(19) United States
(12) Patent Application Publication
(10) Pub. No.: US 2023/0265285 A1
(43) Pub. Date: Aug. 24, 2023

(54) Moisture Curable Adhesive Compositions

(71) Applicant: Kaneka Americas Holding, Inc., Pasadena, TX (US)

(72) Inventors: Jonathan Barrus, Pasadena, TX (US); Ruolei Wang, Pasadena, TX (US); Yoshiteru Masaoka, Pasadena, TX (US)

(73) Assignee: Kaneka Americas Holding, Inc., Pasadena, TX (US)

(21) Appl. No.: 18/024,152

(22) PCT Filed: Sep. 2, 2021
(86) PCT No.: PCT/US2021/048862

§ 371 Date: Mar. 1, 2023

Related U.S. Application Data
(60) Provisional application No. 63/073,667, filed on Sep. 2, 2020.

(51) Int. Cl. C08L 71/02; C08K 5/098; C08J 7/04; C08J 7/043

(52) U.S. Cl. CPC C08L 71/02; C08K 5/098; C08J 7/0427; C08J 7/043; C08J 2371/02; C08J 2323/28

(57) ABSTRACT

A moisture curable composition, a method of applying the same, and a composition including the same are disclosed herein. In some embodiments, a curable composition, comprises: a component (A) having an organic polymer containing reactive silicon groups represented by the following general formula (1): —Si(R¹₃₋ₐ)Xₐ (1) wherein R¹ represents an alkyl group having 1 to 20 carbon atoms, an aryl group having 6 to 20 carbon atoms, or an aralkyl group having 7 to 20 carbon atoms, wherein X represents a hydrolyzable group, wherein each X is the same or different when two or more X are present, a is an integer from 1 to 3, when a is 1, each R¹ may be the same or different, and when a is 2 or 3, each X may be the same or different; a component (B) having a chlorinated polyolefin polymer; and a component (C) having a carboxylic acid metal salt.

### CROSS REFERENCE TO RELATED APPLICATIONS

The present application claims priority from U.S. Provisional Patent Application No. 63/073,667, the disclosure of which is incorporated by reference herein.

### FIELD OF THE INVENTION

The present invention relates to a moisture curable adhesive composition that includes an organic polymer containing reactive silicon groups. The invention relates in particular to a moisture curable adhesive composition having universal adhesiveness to adhesion-resistant substrates, such as polyvinyl chloride (hereinafter defined as “PVC”), ethylene propylene diene rubber (hereinafter defined as “EPDM”), thermoplastic polyolefin (hereinafter referred to as “TPO”), and the like, and the use thereof.

### BACKGROUND OF THE INVENTION

In recent years, investigations have been made for improving the adhesiveness to an adhesion-resistant substrate, such as EPDM, by the addition of a thermoplastic elastomer to a reactive silicon group-containing organic polymer (for example, Japanese Patent No. 4485246B2 to Kanegafuchi Chemical Industry Co., Ltd. and Kaneka Texas Corp.).

U.S. Pat. No. 7,759,425 to Kaneka Corp. describes a moisture curable formulation to improve adhesion to TPO through incorporation of a tackifier and chlorinated polyolefin to reactive silicon group-containing organic polymers.

U.S. Pat. No. 7,767,308 to Chemlink, Inc. describes the use of reactive silicon group-containing organic polymers, phenolic tackifiers, and silane adhesion promoters for bonding with rubber material.

Unfortunately, these formulations cannot lead to universal good adhesion across different substrates, including EPDM, PVC, and TPO. Of these, TPO is generally regarded as the most difficult low surface energy substrate to achieve good adhesion, such that if adhesion to TPO is achieved, EPDM and PVC adhesion subsequently follow. Achieving adhesion to the smooth-back version of these substrates is particularly difficult in comparison to their fleece-back versions, which contain an additional surface treatment to improve adhesion. Solvent based bonding adhesives are still widely used products in the market with excellent adhesion performance on these difficult-to-adhere-to plastic substrates. However, a solvent-based system requires that the solvents be evaporated before the two substrates are mated to each other. This impacts air quality and extends construction timelines. Thus, safety and health concerns for workers arise during manufacturing and, in cases of occupied structures, normal building operations must be suspended due to noxious odors. The solvent-based system may also lead to a significant environmental burden or fire hazard. There is a need to develop an adhesive formulation, which is either solvent-free or contains low amount of solvents, but still can provide universal good adhesion properties on substrates such as, EPDM, PVC, TPO, and the like in both smooth-back and fleece-back variants of the substrates.

### BRIEF SUMMARY OF THE INVENTION

A moisture curable composition is disclosed herein. In some embodiments, a curable composition, comprises: a component (A) having an organic polymer containing reactive silicon groups represented by the following general formula (1): —Si(R¹₃₋ₐ)Xₐ (1) wherein R¹ represents an alkyl group having 1 to 20 carbon atoms, an aryl group having 6 to 20 carbon atoms, or an aralkyl group having 7 to 20 carbon atoms, wherein X represents a hydrolyzable group, wherein each X is the same or different when two or more X are present, a is an integer from 1 to 3, when a is 1, each R¹ may be the same or different, and when a is 2 or 3, each X may be the same or different; a component (B) having a chlorinated polyolefin polymer; and a component (C) having a carboxylic acid metal salt.

In some embodiments, the organic polymer of component (A) comprises a main chain of polyoxypropylene.

In some embodiments, the organic polymer of component (A) comprises a group represented by the following general formula (3): —NR³C(═O)— (3) wherein R³ represents a hydrogen atom, an alkyl group having 1 to 20 carbon atoms, an aryl group having 6 to 20 carbon atoms, or an aralkyl group having 7 to 20 carbon atoms.

In some embodiments, the carboxylic acid metal salt is potassium neodecanoate.

In some embodiments, the composition further comprises an additive.

In some embodiments, the additive is selected from the group consisting of a filler, a dehydration agent, a plasticizer, a stabilizer, and combinations thereof.

A method of applying the curable composition is also disclosed. In some embodiments, the method comprises applying the curable composition to a substrate.

In some embodiments, the substrate is selected from the group consisting of polyvinyl chloride (PVC), ethylene propylene diene rubber (EPDM), and thermoplastic polyolefin (TPO).

In some embodiments, the substrate is thermoplastic polyolefin (TPO).

In some embodiments, the substrate is a smooth-back substrate.

A composition including the curable composition and a substrate is also disclosed.

In some embodiments, the substrate is selected from the group consisting of polyvinyl chloride (PVC), ethylene propylene diene rubber (EPDM), and thermoplastic polyolefin (TPO).

In some embodiments, the substrate is thermoplastic polyolefin (TPO).

In some embodiments, the substrate is a smooth-back substrate.

### DETAILED DESCRIPTION

An object of the present invention is to provide a moisture curable adhesive composition that provides excellent adhesiveness to any surface, including adhesion-resistant surfaces, such as including EPDM, PVC, and TPO, without the use of primers on either smooth-back or fleece-back variants of these substrates. Exemplary EPDM substrates can include Carlisle Sure-Seal® EPDM, Carlisle Sure-White® EPDM, Johns Manville EPDM NR/R, Firestone RubberGard™ EPDM, Firestone Ecowhite™ EPDM, and/or Firestone Fullforce™ EPDM. Exemplary PVC substrates can include GAF EverGuard® PVC, GAF EverGuard® PVC XK, Carlisle Sure-Flex® PVC, Carlisle Sure-Flex® KEE HP, Johns Manville PVC SD Plus, Johns Manville PVC with KEE, and/or Sika Sarnafil PVC. Exemplary TPO substrates can include Firestone UltraPly™ TPO, Firestone UltraPly™ TPO XR, Firestone UltraPly™ TPO Flex Adhered, Firestone Platinum TPO, GAF EverGuard® TPO, GAF EverGuard Extreme® TPO, GAF EverGuard® TPO Ultra, and/or Carlisle Sure-Weld TPO.

A second object of the present invention is to provide a moisture curable adhesive composition having a shelf life of at least about 12 months.

A moisture curable composition includes a component (A) comprising an organic polymer containing reactive silicon groups represented by the following general formula (1):

—Si(R¹₃₋ₐ)Xₐ (1)

wherein R¹ represents an alkyl group having 1 to 20 carbon atoms, an aryl group having 6 to 20 carbon atoms, or an aralkyl group having 7 to 20 carbon atoms, X represents a hydrolyzable group, and a is an integer from 1 to 3, provided that when a is 1 each R¹ may be the same or different, and provided that when a is 2 or 3, each X may be the same or different.

In some embodiments, X represents —OR, wherein R is an alkyl group having 1 to 2 carbon atoms.

When X in general formula (1) is a hydrolyzable group, X is not particularly limited as long as X is a known hydrolyzable group. Specific examples thereof include hydrogen and halogen atoms; and alkoxy, acyloxy, ketoximate, amino, amide, acid amide, aminooxy, mercapto, and alkenyloxy groups. Out of these, alkoxy groups such as methoxy, ethoxy, propoxy and isopropoxy groups are in particular preferred, since the hydrolyzability thereof is mild, allowing the compound to be easily handled.

R¹ in general formula (1) is not particularly limited and either may be an alkyl group having 1 to 20 carbon atoms, an aryl group having 6 to 20 carbon atoms, or an aralkyl group having 7 to 20 carbon atoms. Specific examples thereof include alkyl groups such as methyl, ethyl, propyl and isopropyl groups, aryl groups such as a phenyl group, and aralkyl groups such as a benzyl group. Out of these groups, a methyl group is particularly preferred from the viewpoint of the availability of the starting material.

A specific structure of the reactive silicon group represented by general formula (1) is not particularly limited as long as the structure is known. Particularly preferred are trimethoxysilyl, methyldimethoxysilyl, triethoxysilyl, and methyldiethoxysilyl groups from the viewpoint of the reactivity and the availability thereof.

One species, or two or more species of reactive silicon group may be used in combination in chemical formulas (1).

The introduction of the reactive silicon group into a polyoxyalkylene polymer main chain of component (A) is performed by a known method. Examples thereof include the following methods:

(i) A polyoxyalkylene polymer having a functional group such as a hydroxy group is caused to react with an organic compound having an active group exhibiting reactivity with the functional group and having an unsaturated group, thereby yielding a polyoxyalkylene polymer having the unsaturated group. Alternatively, for example, when an epoxide is subjected to ring-opening polymerization to yield a polyoxyalkylene polymer, an unsaturated group-containing epoxide is ring-opening-copolymerized therewith to yield an unsaturated group-containing polyoxyalkylene polymer. In such a way, a monomer having an unsaturated group unrelated to any polymerization reaction is copolymerized, thereby yielding an unsaturated group-containing organic polymer. Next, a hydrosilane having a reactive silicon group is caused to react onto the resultant reaction production, thereby the reaction product is hydrosilylated.

In order to introduce the reactive silicon group at a high introduction ratio in the method (i), it is preferred to add a hydrosilane compound to an organic polymer containing an unsaturated group represented by CH₂═C(R⁴)—CH₂— or CH(R⁴)═CH—CH₂— wherein R⁴ represents hydrogen or a hydrocarbon group having 1 to 10 carbon atoms, thereby attaining the introduction. More preferably, R⁴ is hydrogen or a methyl group. In order to set the introduction ratio of the reactive silicon group to 85% or more, it is particularly important that R⁴ is a methyl group.

Specific examples of the hydrosilane compound used in the method (i) include halogenated silanes such as trichlorosilane, methyldichlorosilane, dimethylchlorosilane, and phenyldichlorosilane; alkoxysilanes such as trimethoxysilane, triethoxysilane, methyldiethoxysilane, methyldimethoxysilane, and phenyldimethoxysilane; acyloxysilanes such as methyldiacetoxysilane, and phenyldiacetoxysilane; and ketoximate silanes such as bis(dimethyl ketoximate)methylsilane, and bis(cyclohexyl ketoximate)methylsilane. However, the hydrosilane compound is not limited thereto. Out of these compounds, halogenated silanes and alkoxysilanes are particularly preferred, and alkoxysilanes are most preferred since the hydrolyzability of the composition obtained therefrom is mild so that the composition is easily handled.

(ii) A compound having a mercapto group and a reactive silicon group are caused to react with an unsaturated group-containing polyoxyalkylene polymer obtained in the same manner in the method (i).

The synthesis method (ii) is, for example, a method of introducing a compound having a mercapto group and a reactive silicon group into an unsaturated bond moiety of an organic polymer by radical addition reaction in the presence of a radical initiator and/or a radical generating source. However, the method is not particularly limited. Specific examples of the compound having a mercapto group and a reactive silicon group include, but are not limited to, γ-mercaptopropyltrimethoxysilane, γ-mercaptopropylmethyldimethoxysilane, γ-mercaptopropyltriethoxysilane, and γ-mercaptopropylmethyldiethoxysilane.

(iii) A polyoxyalkylene polymer having a functional group such as a hydroxyl group, an epoxy group, or an isocyanate group is caused to react with a compound having a functional group having reactivity to the former functional group and having a reactive silicon group. The functional groups of the compound are not limited, but an isocyanate group or amino group is preferable. An isocyanate group is particularly preferable.

Out of individual choices for the synthesis method (iii), the method for causing a polyoxyalkylene polymer having a hydroxyl group at its terminal to react with a compound having an isocyanate group and a reactive silicon group is, for example, a method described in Japanese Laid-Open Patent Application No. 3-47825. However, the method is not particularly limited. Specific examples of the compound having an isocyanate group and a reactive silicon group include γ-isocyanatopropyl-trimethoxysilane, γ-isocyanatopropyl-methyldimethoxysilane, γ-isocyanatopropyl-triethoxysilane, γ-isocyanatopropyl-methyldiethoxysilane, α-isocyanatomethyl-dimethoxymethylsilane, and α-isocyanatomethyl-trimethoxysilane. However, the compound is not limited thereto.

Out of the above-mentioned methods, method (i) or (iii) is preferred since the polymer obtained by the method (ii) emits a strong odor based on the mercaptosilane. In connection with the method for introducing the reactive silicon group, the organic polymer obtained by the method (i), which has the reactive silicon group(s), is more preferred than the polymer obtained by the method (iii) since the polymer becomes a composition having a low viscosity and a good workability. On the other hand, the method (iii) is preferred since the introduction of a silyl group into a hydroxyl group-containing polymer can be attained only in one step so that the Component (A) can be produced with a good productivity.

Out of individual choices for the method (iii), preferred is a method of causing a polyoxyalkylene polymer having a hydroxyl group at its terminal to react with a compound having an isocyanate group and a reactive silicon group since a high conversion ratio is obtained in a relatively short reaction time. An oxyalkylene polymer obtained by such a reaction is a polymer having the reactive silicon group(s) and a group represented by the following general formula (3):

—NR³—C(═O)— (3)

wherein R³ represents a hydrogen atom, an alkyl group having 1 to 20 carbon atoms, an aryl group having 6 to 20 carbon atoms, or an aralkyl group having 7 to 20 carbon atoms.

Component (A) having a group represented by the general formula (1) can also be obtained by a method other than the above mentioned methods. Specifically, a compound obtained by a chain elongating reaction of a polyol with a diisocyanate compound, for example, an aromatic polyisocyanate, such as toluene(tolylene)diisocyanate, diphenylmethanediisocyanate or xylylenediisocyanate, or an aliphatic polyisocyanate, such as isophoronediisocyanate or hexamethylenediisocyanate, is a compound having a group of the general formula (3), regardless of the method for introducing the reactive silicon group.

Component (A) may be linear or branched, and the number-average molecular weight thereof is 500 or more, 3,000 or more, 15, 000 or less, and or 100,000 or less in terms of polystyrene based on gel permeation chromatography (GPC). The number-average molecular weight is between 1,000 to 50,000, 1,000 to 10,000 or less, 10,000 or more, and 50,000 or less. The molecular weight is measured with the use of HLC-8120GPC (TOSOH CORPORATION) as a solution-sending system, TSK-GEL H type column (TOSOH CORPORATION), and THF solvent.

The reactive silicon group of Component (A) may be bonded to a terminal end of the polyoxyalkylene polymer or along the polymer chain between the terminal ends thereof, or a plurality of the reactive silicon groups may be bonded to both of a terminal end thereof and along the polymer chain between the terminal ends thereof. In particular, when the reactive silicon group is bonded only to the terminal end, the network of the polymer component contained in the composition is effectively constructed. Thus, this case is preferred since a rubbery cured product high in strength and elongation is easily obtained.

As the method for measuring the introduction ratio of the reactive silicon groups in Component (A), various methods can be used. The ratio can be calculated from the integral value of the terminals to which the reactive silicon groups are introduced on the basis of the 1H-NMR spectrum thereof. The introduction ratio of the reactive silicon groups is a numerical value obtained by representing, in percentage, the value obtained by dividing the number of the reactive silicon groups present in the molecule by the number of the terminals of the molecule. Specifically, in the case of a linear polymer (that is, a polymer having two terminal ends), having in a single polymer chain thereof two reactive silicon groups on average an introduction ratio of 100% is calculated out. For this reason, with a polymer wherein many reactive silicon groups are present at moieties other than terminal ends of the polymer chain, the calculated value of the introduction ratio may be over 100%. In the present invention, a linear polymer having reactive silicon groups only at both terminal ends can preferably be used. Usually a polymer of introduction ratio of less than 85% is used. A linear polyoxyalkylene polymer having reactive silicon groups only at both terminal ends thereof can be prepared as follows:

(a) Hydroxyl groups that are present only at the terminal ends of a linear polyoxyalkylene polymer is converted to —OM groups (wherein M is Na or K). The resulting polymer is reacted with an organic halogen compound represented by the formula CH₂═C(R⁴)—CH₂—Z (wherein R⁴ is the same as defined above and Z is a halogen atom) to obtain polyoxyalkylene polymer having an unsaturated group(s) only at its terminal ends. A hydrosilane compound represented by the formula H—Si (R¹₃₋ₐ)Xₐ (wherein R¹, X, and a are the same as defined above) is added to react with a polyoxyalkylene polymer having an unsaturated group(s) only at its terminal ends to obtain a linear polyoxyalkylene polymer with reactive silicon groups only at its terminal ends.

(b) A linear polyoxyalkylene polymer having hydroxyl groups only at the terminal ends thereof is reacted with a compound having isocyanate group and a group represented by the formula —Si(R¹₃₋ₐ)Xₐ (wherein R¹, X, and a are the same as defined above) to obtain a linear polyoxyalkylene polymer with reactive silicon groups only at its terminal ends.

The number of the reactive silicon groups in a single polymer chain of the Component (A) is 0.5 or more on average, 1 or more on average, from 0.8 to 3, or from 1.1 to 5.

Specific examples of the polyoxyalkylene polymer of Component (A), which has reactive silicon group(s), are suggested in Japanese Publication of examined patent application (Kokoku) No. 45-36319, Japanese Publication of examined patent application (Kokoku) No. 46-12154, Japanese Laid-Open Patent Application No. 50-156599, Japanese Laid-Open Patent Application No. 54-6096, Japanese Laid-Open Patent Application No. 55-13767, Japanese Laid-Open Patent Application No. 55-13468, Japanese Laid-Open Patent Application No. 57-164123, Japanese Publication of examined patent application (Kokoku) No. 3-2450, U.S. Pat. Nos. 3,632,557, 4,345,053, 4,366,307 and 4,960,844, and others. Other examples thereof are polyoxyalkylene polymers suggested in Japanese Laid-Open Patent Application No. 61-197631, Japanese Laid-Open Patent Application No. 61-215622, Japanese Laid-Open Patent Application No. 61-215623, and Japanese Laid-Open Patent Application No. 61-218632. The polyoxyalkylene polymers are polymers having a number-average molecular weight of 6,000 or more and a molecular weight distribution (Mw/Mn) of 1.6 or less and having reactive silicon group(s), which have a high molecular weight and a narrow molecular weight distribution. However, the Component (A) is not particularly limited thereto.

The above-mentioned polyoxyalkylene polymers, which each have reactive silicon group(s), may be used alone or in combination of two or more thereof.

The organic polymers of component (A) are commercially available and/or can be prepared in accordance with techniques known in the art. Examples of these polymers containing reactive silicon groups include but are not limited to silyl-terminated polyether and silane-terminated polyurethane. More specific examples of commercially available polymers containing reactive silicon groups for component (A) include but are not limited to KANEKA MS POLYMER® S327, KANEKA MS POLYMER® S227, KANEKA MS POLYMER® S203H, KANEKA SILYL® SAX220, KANEKA SILYL® SAT145, KANEKA SILYL® SAT115, and combinations thereof.

The above exemplary list of commercially available polymers is by no means an exhaustive list and other polymers having reactive silicon groups can be utilized. Further, in some embodiments, it may be beneficial to combine different polymers. For example, in some embodiments, there can be a need to balance a high viscosity grade polymer which is used to lower the modulus for adhesion with a low viscosity grade polymer to allow easy application via brush, trowel, squeegee, spray gun, or other application techniques known in the art. In some embodiments, the organic polymer of component (A) can include a combination of different polymers. For example, one polymer may have a high viscosity and another polymer may have a low viscosity. In some embodiments, the high viscosity may be greater than 20,000 cP at 23° C. In some embodiments, the low viscosity may be lower than 5,000 cP at 23° C. In some embodiments, the low viscosity may be range from 6,000 to 10,000 cP at 23° C. When utilized, the high viscosity grade polymer and the low viscosity grade polymer can be present in a weight ratio of 90:10 to 10:90, preferably 75:25 to 25:75 (high:low viscosity, respectively), based on the total weight of component (A).

The curable composition comprises a component (B) having a chlorinated polyolefin polymer. Component (B) may be utilized as an adhesion promoter in the curable composition. The chlorinated polyolefin polymer of Component (B) used in the present invention is not particularly limited, and may be known in the art. Specific examples thereof include chlorinated polyethylene and chlorinated polypropylene, copolymers thereof, and the chlorinated polyolefins modified with acrylic acid moieties, maleic acid and/or maleic anhydride. Specific examples of chlorinated polyolefin polymers dispersed in solvent or plasticizer include but are not limited to AdvaBond® 8203, AdvaBond® 8232, AdvaBond® 8214, and combinations thereof.

The curable composition comprises a component (C) having a carboxylic acid, and/or a salt thereof. The salt may be a non-metal salt or a metal salt. Component (C) may be utilized as a curing catalyst of component (A). The carboxylic acid and/or salt thereof used in the present invention is not particularly limiting. Exemplary carboxylic acid non-metal salts can include ammonium carboxylate or amine salts of carboxylic acids, among others. Carboxylic acid non-metal salt may consist of carboxylic acid and amine compound. Specific examples of the carboxylic acids are neodecanoic acid, versatic acid, 2-ethylhexanoic acid and octanoic acid. Specific examples of the amine compounds are lauryl amine, N,N-dimethyl-1,3-propanediamine, and N,N-diethyl-1,3-propanediamine. Exemplary carboxylic acid metal salts can include calcium carboxylate, vanadium carboxylate, iron carboxylate, aluminum carboxylate, bismuth carboxylate, titanium carboxylate, potassium carboxylate, barium carboxylate, manganese carboxylate, nickel carboxylate, cobalt carboxylate, tin carboxylate, zinc carboxylate, and zirconium carboxylate. Among these, aluminum carboxylate, titanium carboxylate, potassium carboxylate are preferably used from viewpoint of curability. Specific examples of carboxylic acid metal salts are potassium neodecanoate, bismuth neodecanoate, tin neodecanoate, tin 2-ethylhexanoate, zinc neodecanoate, zirconium neodecanoate, aluminum neodecanoate, aluminum neodecanoate isopropoxide, titanium neodecanoate, titanium neodecanoate isopropoxide. A specific example of a carboxylic acid metal salt is TIB KAT® K25, a potassium neodecanoate, available from TIB CHEMICALS AG of Germany.

The curable composition may contain another curing catalyst besides component (C). For example, organotin compounds, amine compounds, inorganic acids, metal alkoxylates, metal chelates and alkyl ammonium salts are utilized. These can be used solely or in combination. Specific examples are dioctyltin acetoacetate, diazabicyclo[5,4,0]undec-7-en (DBU), phenylguanidine, ortho tolylbiguanide, phosphorus acid, phosphorus acid alkyl ester, titanium isopropoxide, aluminum isopropoxide, zirconium isopropoxide, titanium diisopropoxide bisacetylacetonate, titanium diisopropoxide bis(ethyl acetoacetate), aluminum tris acetylacetonate, tetrabutyl ammonium fluoride, tetrabutyl ammnonium hydroxide.

A moisture curable adhesive composition in accordance with this invention includes about 10 to about 70% by weight of Component (A) based on the total weight of the adhesive compositions; about 0.5 to about 15% by weight of Component (B) based on the total weight of the adhesive compositions, and about 0.1 to about 5% by weight of Component (C) based on the total weight of the adhesive compositions. Surprisingly, these compositions are capable of achieving universal good adhesion across different substrates, including EPDM, PVC and TPO even without using primer. These compositions may be formulated free of or contain a low amount of volatile organic compounds (VOCs), which do not present a significant environmental burden, health risk or fire hazard. The components used for the adhesive compositions are free flowing liquids at room temperature, allowing easy processing during the adhesive manufacturing process.

The moisture curable adhesive composition of the present invention may optionally contain various other additives such as fillers, adhesion promoters, dehydration agents, plasticizers, anti-sagging agents (thixotropic agents), stabilizers, and curing catalysts.

In some embodiments, the moisture curable adhesive composition may contain various fillers. Examples of the fillers include reinforcing fillers such as fumed silica, precipitated silica, crystalline silica, and carbon black; fillers such as heavy calcium carbonate, colloidal calcium carbonate, magnesium carbonate, diatomite, calcined clay, clay, talc, titanium oxide, and bentonite; and fibrous fillers such as glass fibers and filaments. Exemplary fillers include Hubercarb®Q3T, which is a calcium carbonate, available from Huber Engineered Materials of Atlanta, Ga., USA, and Hubercarb®G8, which is a calcium carbonate, available from Huber Engineered Materials.

In some embodiments, the moisture curable adhesive composition may include a dehydration agent to improve the storage stability. A dehydration agent may be, but need not be, limited to an alkoxysilane compound such as n-propyl trimethoxy silane, octyl trimethoxy silane, or vinyl trimethoxy silane. Exemplary dehydration agents can include VTMO, which is a vinyl trimethoxy silane dehydration agent, available from Evonik Industries, and OCTMO, which is a octyl trimethoxy silane dehydration agent, available from Evonik Industries.

In some embodiments, the moisture curable adhesive composition includes adhesion promoters. The adhesion promoter may be selected from a silane coupling agent, a reaction product of a silane coupling agent, or a compound other than silane coupling agents. Specific examples of the silane coupling agent include but are not limited to isocyanate group containing silanes; amino group containing silanes, mercapto group containing silanes; epoxy group containing silanes; vinylically unsaturated group containing silanes; and halogen containing silanes. Other silane coupling agents include derivatives obtained by modifying the foregoing compounds, such as amino modified silyl polymers, unsaturated aminosilane complexes, phenylamino long chain alkyl silanes, aminosilylated silicones, and silylated polyesters. An exemplary adhesion promoter is DAMO-T, which is a aminosilane adhesion promoter, available from Evonik Industries.

In some embodiments, the moisture curable adhesive composition further includes an additional catalyst. Examples of the additional catalyst include amine compounds such as aliphatic primary amines, aliphatic secondary amines, aliphatic tertiary amines, and aliphatic unsaturated amines; nitrogen-containing heterocyclic compounds such as pyridine, imidazole, and amidines such as 1,8-diazabicyclo (5,4,0) undecene-7 (DBU). Exemplary additional catalysts may include Polycat DBU, which is a diazobicycloundecene, available from Evonik Industries, Dyhard OTB, which is 1-(o-Tolyl)biguanide, available from AlzChem Group, and Neostann U220H, which is dibutyltin diacetylacetonate, available from Nitto Kasei Co., Ltd.

In some embodiments, the moisture curable adhesive composition may include an antioxidant. The antioxidant is preferably a hindered phenolic antioxidant. Examples of the hindered phenolic antioxidant include but are not limited to Irganox® 245, Irganox® 1010, and Irganox® 1076, available from BASF, and combinations thereof.

In some embodiments, the moisture curable adhesive composition may include a light stabilizer. The light stabilizer can prevent photo-oxidative degradation of the cured product. Examples of the light stabilizer include but are not limited to benzotriazole compounds, hindered amine compounds, and benzoate compounds.

In some embodiments, the adhesive composition may include an ultraviolet absorber. The ultraviolet absorber can increase the surface weather resistance of the cured product. Examples of the ultraviolet absorber include but are not limited to benzophenone compounds, benzotriazole compounds, salicylate compounds, substituted tolyl compounds, and metal chelate compounds.

In some embodiments, the moisture curable adhesive composition may include thixotropic agent. Specific examples of thixotropic agent include but are not limited to hydrogenated castor oil, organic amide wax, organic bentonite, and calcium stearate. These thixotropic agents may be used alone or in combination of two or more thereof.

In some embodiments, the moisture curable adhesive composition may include plasticizer to control the viscosity. Specific examples of plasticizers include but are not limited to phthalate compounds such as dibutyl phthalate, diisononyl phthalate, di(2-ethylhexyl) phthalate, and diisodecyl phthalate; non-phthalate compounds such as 1,2-cyclohexane dicarboxylic acid diisononyl ester; aliphatic polycarboxylate compounds; unsaturated fatty acid ester compounds, alkyl sulfonic acid phenyl esters, hydrocarbon oils and polymeric plasticizer such as polyether polyols and glycol ether esters. These plasticizers may be used alone or in combination of two or more thereof. An exemplary plasticizer is POLY-G®20-37, which is a polypropylene glycol having a number average molecular weight (Mn) of 3,000 g/mol, available from Monument Chemical of Indianapolis, Ind., USA.

Various other additives may optionally be added to the moisture curable adhesive composition of the present invention in order to control the properties of the curable composition or cured product. Examples of such additives include flame retardants, curability modifiers, lubricants, pigments, and antifungal agents. These additives may be used alone or in combinations of two or more.

### EXAMPLES

The curable composition of the invention will be described on the basis of the following examples; however, the invention is not limited to these examples.

### Comparative Examples 1 to 6 and Inventive Examples 1 to 2

All components were weighed according to the formulations shown in Table 1, and then mixed and kneaded by a mixer under dehydration conditions with substantially no water. Thereafter the mixture was packed into moisture-proof containers (polyethylene cartridge). The curable compositions of Examples 1 to 2 and Comparative Examples 1 to 6 were produced in this way. Unless otherwise noted, each composition was measured after initial formation at 23° C. and then again at 23° C. after storage for 4 weeks at 50° C.The properties of the resultant curable compositions were measured as follows:

Viscosity: A RV type Brookfield viscometer was used to measure the viscosity of each composition (Spindle: No. 6, 10 rpm, and 20 rpm, temperature: 23° C.).

Hand Peel: Substrates were cleaned with isopropyl alcohol and allowed to dry. Adhesive was applied to the substrate and smoothed with a spatula, then cured at 23 C and 50% RH for 3 days followed by curing for 4 days at 50° C. Samples were then cut across the top section of the adhesive to provide a uniform edge, which was then pulled by hand at 180 degrees. Mode of failure was noted as CF=cohesive failure, TF=thin film failure, and AF=adhesive failure.

T-peel: The specimens with size 1.0 inch×6.0 inch were cut from TPO single-ply roof membrane. Each of the compositions was applied on the TPO specimen to form a uniform layer, then another TPO specimen was pressed on top of the adhesive layer. Three testing specimens were prepared for each formulation. The test specimens were allowed to cure at 23° C. and 50% R.H. for 28 days. After 28 days curing, the adhesion strength was measured using Shimadzu tensile tester Model AGS-20KNXD with peeling rate 2 inch/min in accordance with ASTM D 1876, and average peel strength was recorded. T-peel strength lower than 4 pounds per linear inch (“pli”) is considered poor. T-peel strength of between 4-5 pli is considered adequate. T-peel strength of between 5-6 pli is considered good, and T-peel strength higher than 6 pli is considered as excellent.

As shown in the examples set forth below, the use of a carboxylic acid metal salt for component (C) has advantages over other catalysts. The advantage of the examples is clear due to achieving <50% viscosity increase after storage and good or excellent adhesion to TPO. The comparative examples using non-carboxylic acid metal salt catalyst packages all fall short on TPO adhesion with most resulting in an unacceptable viscosity increase as well (>50%) after accelerated oven aging.

Not to be bound by any single theory, the carboxylic acid metal salt is believed to result in a lower modulus cured adhesive, lower than using a conventional dibutyltin catalyst alone but similar to the result of using OTB/dibutyltin together, which helps to promote adhesion to low surface energy substrates, such as TPO. These components when used with common formulation additives at levels achieving suitable formulation economy for commercial purposes achieve excellent adhesion to smooth-back TPO while also demonstrating superior storage stability. The viscosity increase has been shown to be <25% after 4 weeks at 50° C. in accelerated oven testing, which is far superior to an acceptable rate (<50%) of increase for design of a 12 month shelf stable composition to be installed using trowel, squeegee, roller or spray methods. This is a major improvement in viscosity increase versus the higher increase that was observed with previous approaches using OTB/dibutyltin, and further improves on the adhesion of OTB/dibutyltin in economized formulations.

TABLE 1
Adhesive Formulations of Examples and Comparative Examples

| | | | | Comp | Comp | Comp | Comp | Comp | Comp |
|---|---|---|---|---|---|---|---|---|---|
| | | Ex | Ex | Ex | Exe | Ex | Ex | Exe | Ex |
| | | 1 | 2 | 1 | 2 | 3 | 4 | 5 | 6 |
| | | PHR | PHR | PHR | PHR | PHR | PHR | PHR | PHR |
| Component | silyl terminated | 100 | 100 | 100 | 100 | 100 | 100 | 100 | 100 |
| (A) | polyether | | | | | | | | |
| Plasticizer | PPG 3000 | 90 | 90 | 90 | 90 | 90 | 90 | 90 | 90 |
| Calcium | calcium | 280 | 280 | 280 | 280 | 280 | 280 | 280 | 280 |
| Carbonate | carbonate | | | | | | | | |
| Thermal | antioxidant | 2 | 2 | 2 | 2 | 2 | 2 | 2 | 2 |
| Stabilizer | | | | | | | | | |
| Dehydration | vinyl trimethoxy | 5 | 5 | 3 | 3 | 3 | 6 | 6 | 5 |
| Agent | silane | | | | | | | | |
| Dehydration | octyl trimethoxy | | | | 16 | | | | |
| Agent | silane | | | | | | | | |
| Adhesion | aminosilane | 5 | 5 | 6 | 6 | 6 | 6 | 6 | 5 |
| Promoter | | | | | | | | | |
| Component | chlorinated polyolefin | 28 | 28 | 28 | 20 | 20 | 28 | 28 | 28 |
| (B) | polymer | | | | | | | | |
| Catalyst | 1-(o-tolyl)biguanide | | | | | 10 | 10 | 10 | |
| Catalyst | diazobicycloundecene | | 2 | | | | | | 5 |
| Component | potassium carboxylate | 6 | 6 | | | | | | |
| (C) | | | | | | | | | |
| Catalyst | dibutyltin diacetylacetonate | | | 3 | 3 | 3 | 3 | | 2 |
| | Total | 516 | 518 | 512 | 520 | 514 | 525 | 522 | 517 |

TABLE 2
Properties of Examples and Comparative Examples

| | Viscosity (cP) | | | | Hand Peel | | | | |
|---|---|---|---|---|---|---|---|---|---|
| | | | After 4 | Viscosity | | | After 4 | T- | TPO |
| | Speed | | weeks | increase | | | weeks | Peel | Adhesion |
| | (rpm) | Initial | at 50° C. | (%) | | Initial | at 50° C. | (PLI) | Performance |
| Example 1 | 10 | 26,850 | 32,900 | 23 | PVC | CF | CF | 5.87 | Good |
| | 20 | 25,200 | 29,025 | 15 | TPO | AF | CF | | |
| Example 2 | 10 | 30,500 | 46,350 | 52 | PVC | CF | CF | 6.06 | Excellent |
| | 20 | 27,025 | 39,100 | 45 | TPO | AF | CF | | |
| Comparative | 10 | 26,350 | 33,300 | 26 | PVC | CF | CF | 2.65 | Poor |
| Example 1 | 20 | 22,550 | 32,900 | 46 | TPO | AF | AF | | |
| Comparative | 10 | 16,250 | 14,750 | −9 | PVC | CF | CF | 1.66 | Poor |
| Example 2 | 20 | 13,075 | 12,625 | −3 | TPO | AF | TF | | |
| Comparative | 10 | 34,500 | 94,900 | 175 | PVC | CF | CF | 4.46 | Adequate |
| Example 3 | 20 | 31,600 | — | — | TPO | CF | CF | | |
| Comparative | 10 | 22,650 | 96,300 | 325 | PVC | CF | CF | 2.86 | Poor |
| Example 4 | 20 | 20,100 | — | — | TPO | CF | CF | | |
| Comparative | 10 | 27,250 | 47,950 | 76 | PVC | CF | CF | 3.04 | Poor |
| Example 5 | 20 | 23,250 | 41,300 | 78 | TPO | CF | CF | | |
| Comparative | 10 | 25,650 | 41,700 | 63 | PVC | CF | CF | 4.29 | Adequate |
| Example 6 | 20 | 21,950 | 36,350 | 66 | TPO | AF | TF | | |

To summarize, the present disclosure curable composition comprising a component (A) having an organic polymer containing reactive silicon groups represented by the following general formula (1): —Si(R¹₃₋ₐ)Xₐ (1) wherein R¹ represents an alkyl group having 1 to 20 carbon atoms, an aryl group having 6 to 20 carbon atoms, or an aralkyl group having 7 to 20 carbon atoms, wherein X represents a hydrolyzable group, wherein each X is the same or different when two or more X are present, a is an integer from 1 to 3,when a is 1, each R¹ may be the same or different, and when a is 2 or 3, each X may be the same or different; a component (B) having a chlorinated polyolefin polymer; and a component (C) having a carboxylic acid metal salt; and/or
the organic polymer of component (A) comprises a main chain of polyoxypropylene; and/or
the organic polymer of component (A) comprises a group represented by the following general formula (3): —NR³C(═O)— (3) wherein R³ represents a hydrogen atom, an alkyl group having 1 to 20 carbon atoms, an aryl group having 6 to 20 carbon atoms, or an aralkyl group having 7 to 20 carbon atoms; and/or
the carboxylic acid metal salt is potassium neodecanoate; and/or
further comprising an additive; and/or
the additive is selected from the group consisting of a filler, a dehydration agent, a plasticizer, a stabilizer, and combinations thereof.

Also described herein is a method of applying the above-described curable composition, comprising applying the curable composition to a substrate; and/or
the substrate is selected from the group consisting of polyvinyl chloride (PVC), ethylene propylene diene rubber (EPDM), and thermoplastic polyolefin (TPO); and/or
the substrate is thermoplastic polyolefin (TPO); and/or
the substrate is a smooth-back substrate.

Also described herein is a composition comprising a substrate, and the above-described curable composition; and/or
the substrate is selected from the group consisting of polyvinyl chloride (PVC), ethylene propylene diene rubber (EPDM), and thermoplastic polyolefin (TPO); and/or
the substrate is thermoplastic polyolefin (TPO); and/or
the substrate is a smooth-back substrate.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A curable composition, comprising:
an organic polymer containing reactive silicon groups represented by the following general formula (1):
—Si(R¹₃₋ₐ)Xₐ (1)
wherein R¹ represents an alkyl group having 1 to 20 carbon atoms, an aryl group having 6 to 20 carbon atoms, or an aralkyl group having 7 to 20 carbon atoms,
wherein X represents a hydrolyzable group, wherein each X is the same or different when two or more X are present,
a is an integer from 1 to 3,
when a is 1, each R¹ may be the same or different, and
when a is 2 or 3, each X may be the same or different;
a chlorinated polyolefin polymer; and
a carboxylic acid metal salt.

2. The curable composition of claim 1, wherein the organic polymer comprises a main chain of polyoxypropylene.

3. The curable composition of claim 1, wherein the organic polymer comprises a group represented by the following general formula (3):
—NR³C(═O)— (3)
wherein R³ represents a hydrogen atom, an alkyl group having 1 to 20 carbon atoms, an aryl group having 6 to 20 carbon atoms, or an aralkyl group having 7 to 20 carbon atoms.

4. The curable composition of claim 1, wherein the carboxylic acid metal salt is selected from the group consisting of potassium neodecanoate, bismuth neodecanoate, tin neodecanoate, tin 2-ethylhexanoate, zinc neodecanoate, zirconium neodecanoate, aluminum neodecanoate, aluminum neodecanoate isopropoxide, titanium neodecanoate, and titanium neodecanoate isopropoxide.

5. The curable composition of claim 1, further comprising:
an additive.

6. The curable composition of claim 5, wherein the additive is selected from the group consisting of a filler, a dehydration agent, a plasticizer, a stabilizer, and combinations thereof.

7. A method of applying a curable composition, comprising:
applying the curable composition of claim 1 to a substrate.

8. The method of claim 7, wherein the substrate is selected from the group consisting of polyvinyl chloride (PVC), ethylene propylene diene rubber (EPDM), and thermoplastic polyolefin (TPO).

9. The method of claim 7, wherein the substrate is thermoplastic polyolefin (TPO).

10. The method of claim 8, wherein the substrate is a smooth-back substrate.

11. A composition, comprising:
a substrate; and
the curable composition of claim 1.

12. The composition of claim 11, wherein the substrate is selected from the group consisting of polyvinyl chloride (PVC), ethylene propylene diene rubber (EPDM), and thermoplastic polyolefin (TPO).

13. The composition of claim 11, wherein the substrate is thermoplastic polyolefin (TPO).

14. The composition of claim 12, wherein the substrate is a smooth-back substrate.

15. The composition of claim 12, wherein the adhesion strength of the curable composition to the substrate ranges from 5 to 6 or more pounds per linear inch (pli), where the adhesion strength is measured in accordance with ASTM D 1876, after curing the composition at 23 degrees Celsius and 50% relative humidity for 28 days.

16. The curable composition of claim 4, wherein the carboxylic acid metal salt is potassium neodecanoate.

17. The curable composition of claim 1, wherein the chlorinated polyolefin polymer includes one of chlorinated polyethylene, chlorinated polypropylene, copolymers thereof, or a chlorinated polyolefin polymer modified with at least one of acrylic acid moieties, maleic acid, or maleic acid anhydride.

18. The curable composition of claim 1, wherein the organic polymer is present in an amount of about 10% to about 70% by weight,
wherein the chlorinated polyolefin is present in an amount of about 0.5% to about 15% by weight, and
wherein the carboxylate metal salt is present in an amount of about 0.1 to about 5% by weight, based on the total weight of the curable composition.

19. The curable composition of claim 1, wherein the curable composition has a change in viscosity of less than 50% after storage at 50 degrees Celsius for 4 weeks.
